(19) United States
(12) Patent Application Publication
(10) Pub. No.: US 2022/0177378 A1
(43) Pub. Date: Jun. 9, 2022

(54) CERAMIC COMPONENT

(71) Applicant: RAYTHEON TECHNOLOGIES CORPORATION, Farmington, CT (US)

(72) Inventors: Kathryn S. Read, Marlborough, CT (US); Andrew J. Lazur, Laguna Beach, CA (US); Afshin Bazshushtari, Rolling Hills Estates, CA (US)

(21) Appl. No.: 17/110,945

(22) Filed: Dec. 3, 2020

(51) Int. Cl. C04B 35/80; F01D 9/04; F01D 5/28; B32B 5/02; D03D 15/242; B32B 5/26; B32B 7/12

(52) U.S. Cl. CPC C04B 35/80; C04B 2235/5256; F01D 5/284; B32B 5/024; D03D 15/242; B32B 5/26; B32B 7/12; F05D 2220/32; F05D 2240/12; F05D 2240/30; F05D 2300/6012; F05D 2300/6033; F05D 2300/2261; F05D 2300/5023; B32B 2262/105; B32B 2603/00; D03D 2700/0174; D10B 2101/08; C04B 2235/3826; C04B 2235/5244; F01D 9/041

(57) ABSTRACT

A ceramic matrix composite includes at least one ply of ceramic fibers and a a ceramic matrix material deposited on the ceramic fibers. A fiber volume fraction is between about 35-45% and an areal weight fibers is between about 150-450 g/m2. A method of fabricating a ceramic matrix composite component is also disclosed.

### BACKGROUND

A gas turbine engine typically includes a fan section, a compressor section, a combustor section and a turbine section. Air entering the compressor section is compressed and delivered into the combustion section where it is mixed with fuel and ignited to generate a high-speed exhaust gas flow. The high-speed exhaust gas flow expands through the turbine section to drive the compressor and the fan section. The compressor section typically includes low and high pressure compressors, and the turbine section includes low and high pressure turbines.

One example ceramic material is a ceramic matrix composite (“CMC”), which includes, generally, ceramic-based reinforcements (such as fibers) in a ceramic-based material. CMCs have high temperature resistance, and are therefore being considered for use in gas turbine engines, which have areas that operate at very high temperatures. For instance, CMCs are being considered for use in the compressor section, and for airfoils and/or blade outer air seals (“BOAS”) in the compressor/turbine sections. Despite its high temperature resistance, there are unique challenges to implementing CMC components in gas turbine engines.

### SUMMARY

A ceramic matrix composite according to an exemplary embodiment of this disclosure, among other possible things includes at least one ply of ceramic fibers and a a ceramic matrix material deposited on the ceramic fibers. A fiber volume fraction is between about 35-45% and an areal weight fibers is between about 150-450 g/m2.

In a further example of the foregoing, the fibers are woven together in a triaxial braid weave.

In a further example of any of the foregoing, the fibers are woven together in a harness satin weave.

In a further example of any of the foregoing, the fibers are woven together in an 8-harness satin weave.

In a further example of any of the foregoing, the fiber volume fraction is between about 35-40%.

In a further example of any of the foregoing, the fiber volume fraction is between about 37-39%.

In a further example of any of the foregoing, the areal weight is between about 200-300 g/m2.

In a further example of any of the foregoing, wherein the areal weight is between about 240-270 g/m2 and the fibers are woven together in an 8 harness satin weave.

In a further example of any of the foregoing, wherein the areal weight is between about 200-230 g/m2 and the fibers are arranged in at least one triaxial braid.

In a further example of any of the foregoing, the fiber volume fraction is between about 36-39% and the areal weight is between about 240-270 g/m2. The fibers are woven together in an 8 harness satin weave.

In a further example of any of the foregoing, wherein the fiber volume fraction is between about 36-39% and the areal weight is between about 200-230 g/m2. The fibers are arranged in at least one triaxial braid.

In a further example of any of the foregoing, the fibers and matrix comprise silicon carbide (SiC).

In a further example of any of the foregoing, the ceramic matrix composite makes up a component of a gas turbine engine.

In a further example of any of the foregoing, the component is one of an airfoil and a blade outer air seal.

A method of fabricating a ceramic matrix composite component according to an exemplary embodiment of this disclosure, among other possible things includes providing a ply, the ply including a plurality of ceramic fibers; laying up the ply with a second ply, the second ply including a plurality of ceramic fibers; and infiltrating the first and second plies with a ceramic matrix material. A fiber volume fraction is between about 35-45% and an areal weight fibers is between about 150-450 g/m2.

In a further example of the foregoing, wherein the fiber volume fraction is between about 36-39% and the areal weight is between about 240-270 g/m2. The fibers are woven together in an 8 harness satin weave.

In a further example of any of the foregoing, the fiber volume fraction is between about 36-39% and the areal weight is between about 200-230 g/m2. The fibers are arranged in at least one triaxial braid.

In a further example of any of the foregoing, the ceramic fibers and the ceramic matrix comprise silicon carbide (SiC).

In a further example of any of the foregoing, the method includes weaving the fibers into a weave, wherein the weave is one of a triaxial braid weave and an 8-harness satin weave.

In a further example of any of the foregoing, the method includes consolidating the first and second plies prior to the infiltrating step.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates an example gas turbine engine.

FIG. 2 illustrates an example CMC component, for the gas turbine engine of FIG. 1.

FIG. 3 illustrates an example fiber ply for a CMC component such as the example component of FIG. 2.

FIGS. 4A-B illustrate a schematic cutaway view of a high porosity and low porosity CMC material, respectively.

FIGS. 4C-D show schematic representations of pores in the high porosity and low porosity CMC materials of FIGS. 4A-B.

### DETAILED DESCRIPTION

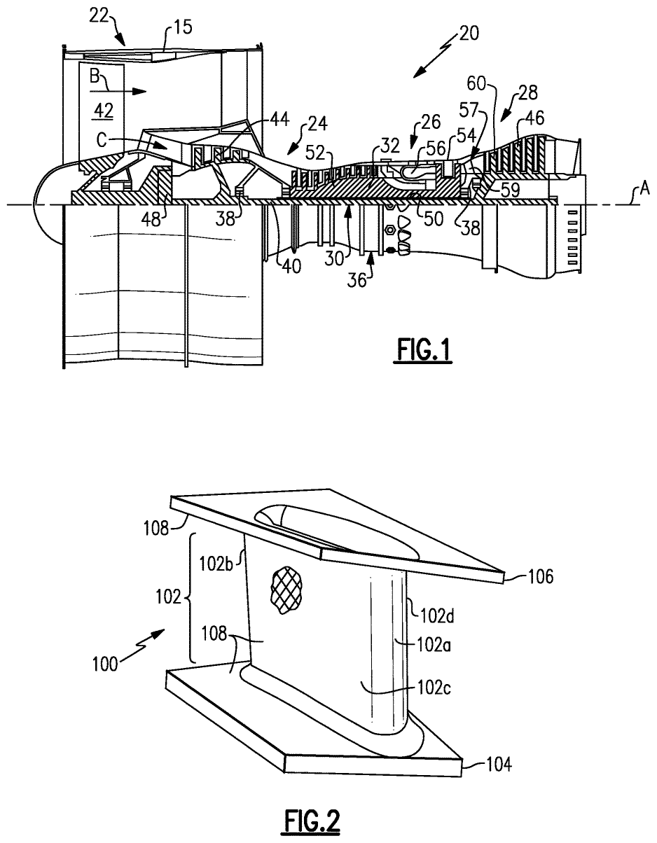

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. The fan section 22 drives air along a bypass flow path B in a bypass duct defined within a nacelle 15, and also drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects, a first (or low) pressure compressor 44 and a first (or low) pressure turbine 46. The inner shaft 40 is connected to the fan 42 through a speed change mechanism, which in exemplary gas turbine engine 20 is illustrated as a geared architecture 48 to drive a fan 42 at a lower speed than the low speed spool 30. The high speed spool 32 includes an outer shaft 50 that interconnects a second (or high) pressure compressor 52 and a second (or high) pressure turbine 54. A combustor 56 is arranged in exemplary gas turbine 20 between the high pressure compressor 52 and the high pressure turbine 54. A mid-turbine frame 57 of the engine static structure 36 may be arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded through the high pressure turbine 54 and low pressure turbine 46. The mid-turbine frame 57 includes airfoils 59 which are in the core airflow path C. The low pressure turbine 46 incudes airfoils 60. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of the low pressure compressor, or aft of the combustor section 26 or even aft of turbine section 28, and fan 42 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1 and less than about 5:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (10,668 meters). The flight condition of 0.8 Mach and 35,000 ft (10,668 meters), with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]\hat{ }0.5. The “Low corrected fan tip speed” as disclosed herein according to one non-limiting embodiment is less than about 1150 ft/second (350.5 meters/second).

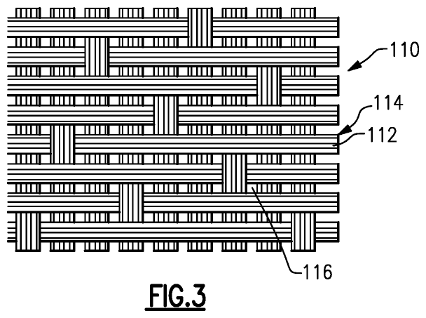

Ceramic matrix composites (“CMC”) can be employed in various areas of the engine 20 described above and shown in FIG. 1 For instance, CMC components, or components that are at least partly CMC, can be used in the combustor section 26, or in the turbine/compressor sections 24/28. FIG. 2 shows one non-limiting example CMC component, which is a representative airfoil 100 used in the engine 20 (see also FIG. 1). As shown, the airfoil 100 is a turbine vane; however, it is to be understood that, although the examples herein may be described and shown with reference to turbine vanes, this disclosure is also applicable to blades. Moreover, it should be understood that the description herein is applicable to other types of CMC components, and is not limited to airfoils.

In the illustrated example, the airfoil 100 includes an airfoil section 102 that delimits an aerodynamic profile. Airfoil section 102 defines a leading end 102a, a trailing end 102b, and first and second sides 102c/102d that join the leading end 102a and the trailing end 102b. The terminology “first” and “second” as used herein is to differentiate that there are two architecturally distinct components or features. It is to be further understood that the terms “first” and “second” are interchangeable in the embodiments herein in that a first component or feature could alternatively be termed as the second component or feature, and vice versa. In this example, the first side 102c is a pressure side and the second side 102d is a suction side. The airfoil section 102 generally extends in a radial direction relative to the central engine axis A. For a vane, the airfoil section 102 spans from a first or inner platform 104 to a second or outer platform 106. The terms “inner” and “outer” refer to location with respect to the central engine axis A, i.e., radially inner or radially outer. For a blade, the airfoil section 102 would extend from a single inner platform to a free end.

The airfoil section 102 and platforms 104/106 together constitute an airfoil piece. For a blade, the airfoil piece would include only the airfoil section 102 and platform 104. In one example, the airfoil piece is formed of a single, continuous wall 108 that defines the complete or substantially complete shape and contour of the airfoil section 102 and platforms 104/106. In this regard, the airfoil 100 is a unibody construction.

The subsequent description of CMC material may refer to the wall 108 for the unibody example discussed above. However, as noted, the CMC material described herein is applicable to various other uses within the gas turbine engine, including non-unibody airfoil constructions or components for other parts of the gas turbine engine 20 discussed above. Therefore, references to the wall 108 should not be viewed as limiting in this respect.

The wall 108 is formed of a ceramic matrix composite (“CMC”) material. CMCs are comprised of a ceramic reinforcement, such as ceramic fibers, in a ceramic matrix. Example ceramic matrices of the CMC are silicon-containing ceramic, such as but not limited to, a silicon carbide (SiC) matrix or a silicon nitride (Si₃N₄) matrix. Example ceramic reinforcement of the CMC are silicon-containing ceramic fibers, such as but not limited to, silicon carbide (SiC) fiber or silicon nitride (Si₃N₄) fibers.

FIG. 3 shows a ply 110 of CMC material, which is also schematically shown in a cutaway section in FIG. 2. A ply 110 of CMC material consists of ceramic fibers 112 woven or stacked together. In one example, the fibers 112 are arranged into bundles, known as tows 114. A ceramic material 116 is disposed onto the fibers 112 or tows 114. One example CMC is a SiC/SiC CMC in which SiC fibers 112 are disposed within a SiC matrix 116. The wall 108 is therefore comprised of at least one CMC ply 110 and in some examples includes multiple CMC plies 110, such as two, three, or four plies.

In some examples, the fibers 112 and/or tows 114 include an interface coating, which modifies the properties of the fibers 112 and thus the resulting CMC material. An example interface coating can include layers of boron nitride, carbon, or both.

Various weave patterns/fiber arrangements that are known in the art can be employed in the ply 110. For instance, in the example of FIG. 5, a harness satin weave is shown. Harness satin weaves are those in which four or more weft fiber tow 114 pass over a warp fiber tow 114, and four or more warp fiber tows 114 pass under a single weft fiber tow 114. In further examples, the ply 110 is a harness weave and has a harness number from 5 to 12 (e.g., 8 harness weave or 12 harness weave). For a harness number of 5, four weft fiber tows 114 pass over a warp fiber tow 114, and four warp fiber tows 114 pass under a single weft fiber tow 114. In other words, the number of fiber tows 114 passed over/under is one less than the numeral of the harness number.

Other weave patterns, such as twill, or fiber arrangements, such as biaxial braids or triaxial braids, are also contemplated, as are unidirectional arrangements of fibers 112/tows 114 or other non-woven arrangements.

In some examples, once the fibers 112/tows 114 are arranged into the ply 110, the ply 110 is stabilized by the application of a binder. In further examples, the binder can also serve to retain the edges of the ply 110, or a mechanical form of edge retention could be used.

The general procedure for forming the ply or plies 110 into a CMC material is as follows. The ply or plies 110 are first preformed, which can include orienting the ply 110 into a desired orientation (which may be based on the weave pattern/fiber arrangement). The ply 110 may be cut, if desired. The ply 110 may also be preformed into a shape near the shape of the desired final component, such as the airfoil wall 108. After preforming, the ply 110 is “layed-up” which includes stacking multiple preformed plies 110. A binder may be used to adhere the plies 110 to one another. After laying up, the plies 110 undergo matrix 116 infiltration. One example method of matrix 116 infiltration is chemical vapor infiltration (“CVI”), which is well-known in the art. In some examples, an optional consolidation step is performed prior to matrix 116 infiltration, which can include compressing the plies 110. After matrix 116 infiltration, the resulting CMC can undergo various further processing steps, such as drying.

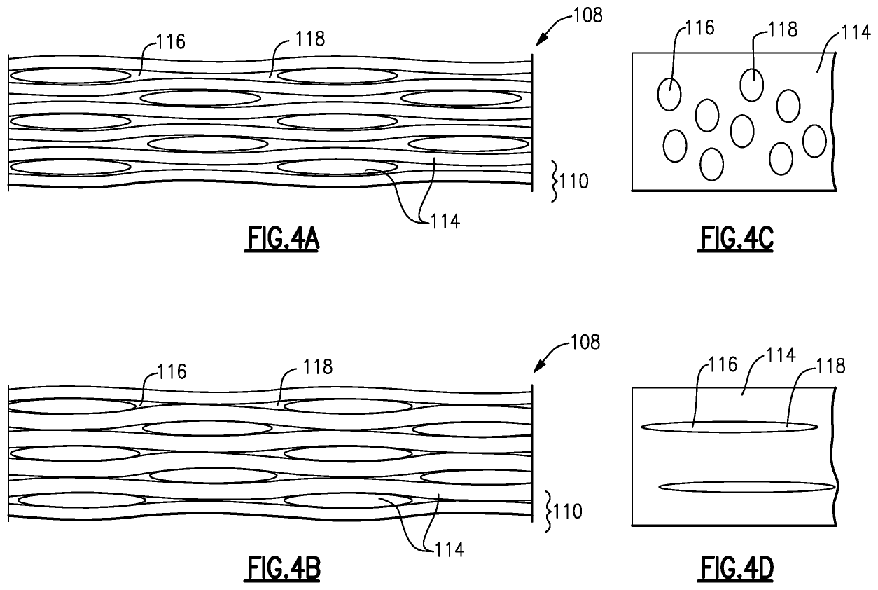

FIGS. 4A-B show a cutaway view of example high porosity and low porosity CMC materials, respectively. In this example tows 114 are shown, though it should be understood that in other examples tows 114 may not be used, as discussed above. Pores 118 are the spaces between adjacent tows 114. Porosity relates to the amount of space (which is filled with matrix material 116) between adjacent tows 114, and includes the sum of both intertow porosity and interfiber porosity. Porosity is inversely related to fiber volume fraction, which is expressed as a percentage of the volume of a CMC component, such as wall 108, that is filled with fibers 112. In general, the higher the fiber volume fraction of a CMC component, the lower the porosity, and the less space for matrix 116 infiltration.

In general, the matrix material 116 is more uniform when it is deposited in a smaller space with a larger surface area. A schematic representation of the pores 118 is shown in FIGS. 4C-D. For a high porosity CMC material, the pores 118 can approach the shape of a sphere as shown in FIGS. 4A/4C. For a low porosity CMC material, the pores 118 are more elongated and thus have a larger surface area, as shown in FIGS. 4B/4D. More uniform matrix 116 material generally exhibits improved mechanical properties. Moreover, more uniform material 116 material is associated with improved interlaminar properties such as interlaminar strength (which is related to the amount of force that the CMC material can withstand before the individual plies 110 come apart).

In some examples, particulates of matrix 116 material, such as SiC, are provided to the layup prior to infiltration of the matrix 116 material. The particulates can serve as nucleation sites for the deposition of matrix 116 material, which leads to improved matrix 116 uniformity.

In one example, the fiber volume fraction for the CMC material is between about 28-42%. In this range, the matrix uniformity is improved as compared to CMC materials with fiber volume fractions outside of the range, which was confirmed by measuring the thermal diffusivity of the CMC material compared to other CMC materials as well as by x-ray computed tomography imaging. Moreover, the overall interlaminar strength and interlaminar tension of the resulting CMC material was improved as compared to CMC materials with fiber volume fractions outside of that range. In a further example, the fiber volume fraction is between about 35-40%. In a specific example, the fiber volume fraction is between about 36-39%.

The fiber volume fraction of a CMC material is related to certain architectural properties, such as areal weight and fiber architecture (e.g., weave pattern or fiber 112 arrangement) as well as certain processing parameters, such as the amount of compression provided during the optional consolidation step discussed above.

In one example, the areal weight of the plies 110, which is a measure of the weight of fibers 112 in a given area, is between about 150-450 g/m². In a further example, the areal weight of the CMC material is between about 200-300 g/m². In a specific example, the areal weight of the CMC material is between about 240-270 g/m² and the weave is an 8HS weave. In a specific example the areal weight of the CMC material is between about 200-230 g/m² and the fibers 112 are arranged in triaxial braid(s).

One specific example CMC material has the following properties. The fiber volume fraction is between about 35-45%. The areal weight is between about 150-450 g/m². The fibers are arranged in an 8-harness satin weave pattern.

Another specific example CMC material has the following properties. The fiber volume fraction is between about 35-40%. The areal weight is between about 200-300 g/m². The fibers are arranged in triaxial braid(s).

Another specific example CMC material has the following properties. The fiber volume fraction is between about 35-40%. The areal weight is between about 200-300 g/m². The fibers are arranged in 8-harness satin weave pattern.

Another specific example CMC material has the following properties. The fiber volume fraction is between about 37-39%. The areal weight is between about 200-230 g/m². The fibers are arranged in triaxial braid(s).

Another specific example CMC material has the following properties. The fiber volume fraction is between about 36-39%. The areal weight is between about 240-270 g/m². The fibers are arranged in 8-harness satin weave.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from this disclosure. The scope of legal protection given to this disclosure can only be determined by studying the following claims.

What is claimed is:

1. A ceramic matrix composite, comprising:
at least one ply of ceramic fibers; and
a ceramic matrix material deposited on the ceramic fibers, wherein a fiber volume fraction is between about 35-45% and an areal weight fibers is between about 150-450 g/m².

2. The ceramic matrix composite of claim 1, wherein the fibers are woven together in a triaxial braid weave.

3. The ceramic matrix composite of claim 1, wherein the fibers are woven together in a harness satin weave.

4. The ceramic matrix composite of claim 3, wherein the fibers are woven together in an 8-harness satin weave.

5. The ceramic matrix composite of claim 1, wherein the fiber volume fraction is between about 35-40%.

6. The ceramic matrix composite of claim 5, wherein the fiber volume fraction is between about 37-39%.

7. The ceramic matrix composite of claim 1, wherein the areal weight is between about 200-300 g/m².

8. The ceramic matrix composite of claim 7, wherein the areal weight is between about 240-270 g/m² and the fibers are woven together in an 8 harness satin weave.

9. The ceramic matrix composite of claim 7, wherein the areal weight is between about 200-230 g/m² and the fibers are arranged in at least one triaxial braid.

10. The ceramic matrix composite of claim 1, wherein the fiber volume fraction is between about 36-39% and the areal weight is between about 240-270 g/m², and wherein the fibers are woven together in an 8 harness satin weave.

11. The ceramic matrix composite of claim 1, wherein the fiber volume fraction is between about 36-39% and the areal weight is between about 200-230 g/m², and wherein the fibers are arranged in at least one triaxial braid.

12. The ceramic matrix composite of claim 1, wherein the fibers and matrix comprise silicon carbide (SiC).

13. The ceramic matrix composite of claim 1, wherein the ceramic matrix composite forms at least part of a component of a gas turbine engine.

14. The ceramic matrix composite of claim 13, wherein the component is one of an airfoil and a blade outer air seal.

15. A method of fabricating a ceramic matrix composite component, comprising:
providing a ply, the ply including a plurality of ceramic fibers;
laying up the ply with a second ply, the second ply including a plurality of ceramic fibers; and
infiltrating the first and second plies with a ceramic matrix material, wherein a fiber volume fraction is between about 35-45% and an areal weight fibers is between about 150-450 g/m^{2.}

16. The method of claim 15, wherein the fiber volume fraction is between about 36-39% and the areal weight is between about 240-270 g/m², and wherein the fibers are woven together in an 8 harness satin weave.

17. The method of claim 15, wherein the fiber volume fraction is between about 36-39% and the areal weight is between about 200-230 g/m², and wherein the fibers are arranged in at least one triaxial braid.

18. The method of claim 15, wherein the ceramic fibers and the ceramic matrix comprise silicon carbide (SiC).

19. The method of claim 15, further comprising weaving the fibers into a weave, wherein the weave is one of a triaxial braid weave and an 8-harness satin weave.

20. The method of claim 15, further comprising consolidating the first and second plies prior to the infiltrating step.
